(19) United States
(12) Patent Application Publication
(10) Pub. No.: US 2025/0077063 A1
(43) Pub. Date: Mar. 6, 2025

(54) METHOD FOR ACTIVATING SYSTEM FUNCTION, HOST, AND COMPUTER READABLE STORAGE MEDIUM

(71) Applicant: HTC Corporation, Taoyuan City (TW)

(72) Inventors: Jing-Lung Wu, Taoyuan City (TW); Sheng-Yang Pan, Taoyuan City (TW)

(73) Assignee: HTC Corporation, Taoyuan City (TW)

(21) Appl. No.: 18/607,589

(22) Filed: Mar. 18, 2024

Related U.S. Application Data
(60) Provisional application No. 63/535,074, filed on Aug. 29, 2023.

(51) Int. Cl. G06F 3/04847; G06F 3/04817; G06F 3/04883

(52) U.S. Cl. CPC G06F 3/04847; G06F 3/04817; G06F 3/04883

(57) ABSTRACT

The embodiments of the disclosure provide a method for activating a system function, a host, and a computer readable storage medium. The method includes: providing a visual content; tracking a first motion state of a physical object by using a tracking device; and in response to determining that the first motion state of the physical object indicates that a distance between the physical object and the host is less than a first distance threshold and the physical object corresponds to a first content region in the visual content, performing a first system function corresponding to the first content region, wherein the first content region corresponds to a first physical region on a body of the host.

### CROSS-REFERENCE TO RELATED APPLICATION

This application claims the priority benefit of U.S. provisional application Ser. No. 63/535,074, filed on Aug. 29, 2023. The entirety of the above-mentioned patent application is hereby incorporated by reference herein and made a part of this specification.

### BACKGROUND

### 1. Field of the Invention

The present disclosure generally relates to a mechanism for controlling a host, in particular, to a method for activating a system function, a host, and a computer readable storage medium.

### 2. Description of Related Art

Nowadays, it is common for people to use head-mounted displays (HMD) to experience reality services such as the virtual reality (VR) service, augmented reality (AR) service, and mixed reality service, etc.

In general, the body of the HMD would be disposed with one or more hardware/physical components for the user to activate particular system functions, such as powering on/off, volume adjusting, opening system menu, etc. However, when the user is wearing the HMD, it would be difficult for the user to accurately reach/find the positions of the hardware buttons since the hardware/physical components may not be seen by the user. In this case, the user may not be able to trigger the desired system functions.

### SUMMARY OF THE INVENTION

Accordingly, the disclosure is directed to a method for activating a system function, a host, and a computer readable storage medium, which may be used to solve the above technical problems.

The embodiments of the disclosure provide a method for activating a system function, applied to a host. The method includes: providing, by the host, a visual content; tracking, by the host, a first motion state of a physical object by using a tracking device; and in response to determining that the first motion state of the physical object indicates that a distance between the physical object and the host is less than a first distance threshold and the physical object corresponds to a first content region in the visual content, performing, by the host, a first system function corresponding to the first content region, wherein the first content region corresponds to a first physical region on a body of the host.

The embodiments of the disclosure provide a host including a storage circuit, a tracking device, and a processor. The storage circuit stores a program code. The processor is coupled to the non-transitory storage circuit and the tracking device, and accesses the program code to perform: providing a visual content; tracking a first motion state of a physical object by using the tracking device; and in response to determining that the first motion state of the physical object indicates that a distance between the physical object and the host is less than a first distance threshold and the physical object corresponds to a first content region in the visual content, performing a first system function corresponding to the first content region, wherein the first content region corresponds to a first physical region on a body of the host.

The embodiments of the disclosure provide a computer readable storage medium, the computer readable storage medium recording an executable computer program, the executable computer program being loaded by a host to perform steps of: providing a visual content; tracking a first motion state of a physical object by using a tracking device; and in response to determining that the first motion state of the physical object indicates that a distance between the physical object and the host is less than a first distance threshold and the physical object corresponds to a first content region in the visual content, performing a first system function corresponding to the first content region, wherein the first content region corresponds to a first physical region on a body of the host.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a host according to an embodiment of the disclosure.

FIG. 2 shows a flow chart of the method for activating a system function according to an embodiment of the disclosure.

FIG. 3 shows an application scenario according to an embodiment of the disclosure.

FIG. 4 shows a flow chart of the method for activating a system function according to a first embodiment of the disclosure.

FIG. 5 shows a flow chart of the method for activating a system function according to a second embodiment of the disclosure.

FIG. 6 shows a flow chart of the method for activating a system function according to a third embodiment of the disclosure.

FIG. 7 shows a flow chart of the method for activating a system function according to a fourth embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

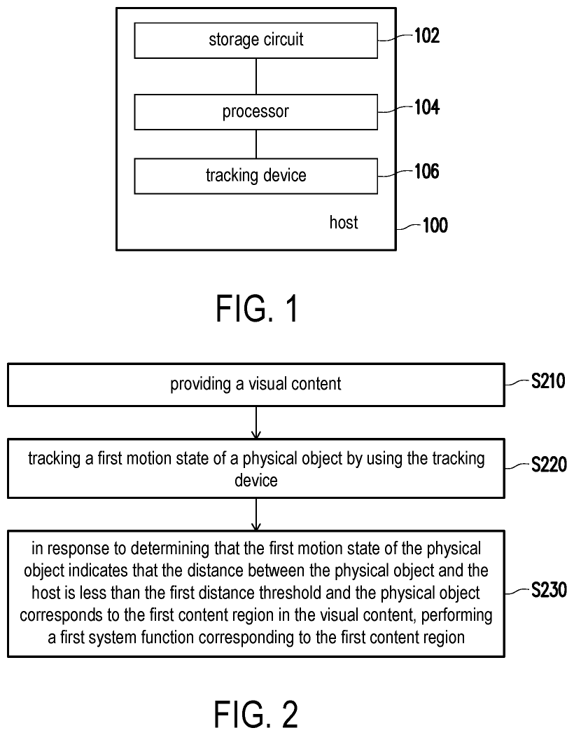

See FIG. 1, which shows a schematic diagram of a host according to an embodiment of the disclosure. In FIG. 1, the host 100 can be any electronic device such as smart devices and/or computer devices. In some embodiments, the host 100 can be a head-mounted display (HMD) that provides the visual content of reality services such as AR/VR/MR services for the user to experience.

In FIG. 1, the host 100 includes a storage circuit 102, a processor 104, and a tracking device 106. The storage circuit 102 is one or a combination of a stationary or mobile random access memory (RAM), read-only memory (ROM), flash memory, hard disk, or any other similar device, and which records a plurality of modules that can be executed by the processor 104.

The processor 104 may be coupled with the storage circuit 102 and the tracking device 106, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In some embodiments, the tracking device 106 may be implemented as tracking cameras, proximity sensors, distance sensor, or the like, and may be used to track the motion state of one or more physical object (e.g., hands) moving near the host 100. In some embodiments, the motion state of the physical object may include, but not limited to, the moving speed of the physical object, the distance between the physical object and the host 100.

In some embodiments, the tracking device 106 may be disposed with a field of view (FOV). When the physical object is in the FOV of the tracking device 106, the processor 104 may determine the corresponding object position of the physical object in the visual content.

In some embodiments, when the visual content is designed with one or more content regions, the processor 104 may further determine the duration of the physical object corresponding to the content region(s). For example, if the corresponding object position of the physical object is determined to be staying in a first content region of the content regions for K seconds, the processor 104 may determine that the duration of the physical object corresponding to the first content region is K seconds, but the disclosure is not limited thereto.

In the embodiments of the disclosure, the processor 104 may access the modules and/or the program code stored in the storage circuit 102 to implement the method for activating a system function provided in the disclosure, which would be further discussed in the following.

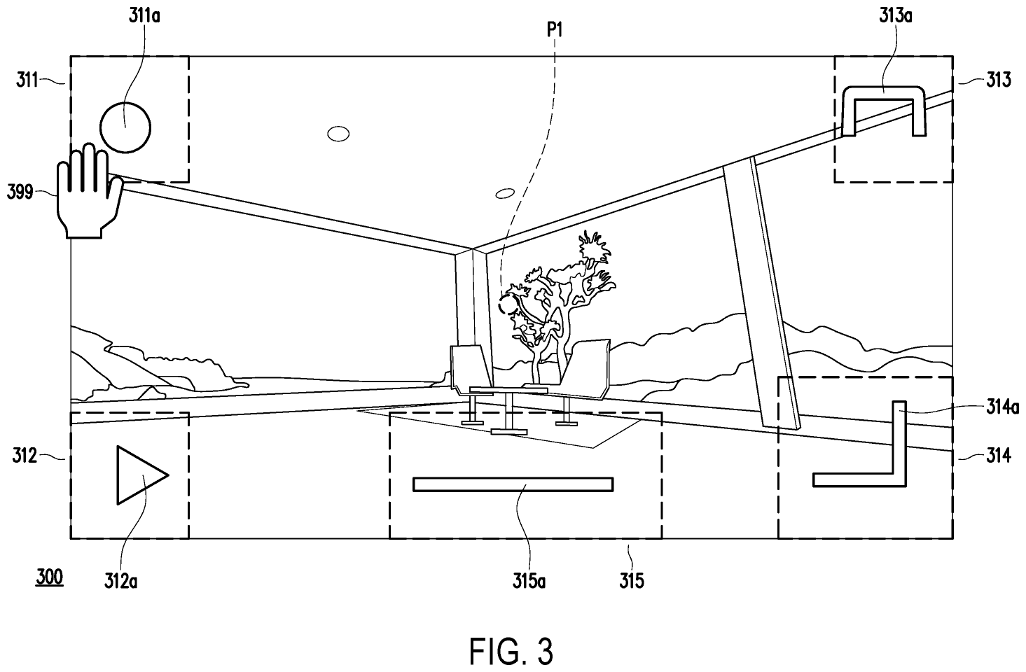

See FIG. 2, which shows a flow chart of the method for activating a system function according to an embodiment of the disclosure. The method of this embodiment may be executed by the host 100 in FIG. 1, and the details of each step in FIG. 2 will be described below with the components shown in FIG. 1. In addition, FIG. 3 would be used as an example for better explaining the concept of the disclosure, wherein FIG. 3 shows an application scenario according to an embodiment of the disclosure.

In step S210, the processor 104 provides a visual content 300. In FIG. 3, the visual content 300 may be, for example, a VR content, but the disclosure is not limited thereto.

In the present embodiment, the visual content 300 may be designed with content regions 311-315 corresponding to different system functions. For example, the content region 311 may correspond to the system function of powering on/off; the content region 312 may correspond to the system function of volume adjusting; the content region 313 may correspond to the system function of activating a function of an external device connecting to a particular port on the body of the host 100; the content region 314 may correspond to the system function of showing a menu of the reality service (e.g., the VR service) and/or scrolling the menu; the content region 315 may correspond to the system function of configuring the Interpupillary distance (IPD), but the disclosure is not limited thereto.

In addition, the content region 311-315 may be designed with the corresponding icons 311a-315a for providing visual aids for the corresponding system functions.

In some embodiments, one or more of the icons 311a-315a may be invisible by default, and the processor 104 may show the icons 311a-315a in response to determining that some particular events have been detected, which would be discussed later.

In step S220, the processor 104 tracking a first motion state of a physical object 399 by using the tracking device 106. In FIG. 3, the physical object 399 would be assumed to be the hand of the user, but the disclosure is not limited thereto. In other embodiments of the disclosure, the considered physical object may be any object moving near the host 100, such as handheld controllers (e.g., VR/XR handheld controllers) used for interacting with the visual content 300, but the disclosure is not limited thereto.

As mentioned in the above, the processor 104 may determine the object position of the physical object 399 in the visual content 300, and this object position may be the position exemplarily shown in FIG. 3. In some embodiments, the physical object 399 may not be shown in the visual content 300. Instead, the visual content 300 may show a virtual object whose appearance/position correspond to the physical object 399, such as a virtual hand, a virtual handheld controller, or the like.

In one embodiment, the processor 104 may determine whether the physical object 399 corresponds to a first content region in the visual content 300

For example, the processor 104 may determine whether the object position of the physical object 399 is within the first content region among the content regions 311-315 or whether the object position is distant from the first content region by less than a distance threshold. In one embodiment, in response to determining that the object position of the physical object 399 is within the first content region of the content regions 311-315 or the object position is distant from the first content region by less than the distance threshold, the processor 104 may determine that the physical object 399 corresponds to the first content region. On the other hand, in response to determining that the object position of the physical object 399 is not within the first content region and the object position is not distant from the first content region by less than the distance threshold, the processor 104 may determine that the physical object 399 does not correspond to the first content region.

In various embodiments, the distance threshold may be determined based on the requirements of the designer. For example, the distance threshold may be determined based on the size of the physical object 399, such as being determined as the width and/or the height of the physical object 399. For another example, the distance threshold may be also determined based on the size of the first content region, such as being determined as the width and/or the height of the first content region. From another perspective, even if the physical object 399 completely locates outside of the first content, the physical object 399 may still be determined to be corresponding to the first content region in the case where the object position thereof is closed to the first content region, but the disclosure is not limited thereto.

In FIG. 3, since the object position of the physical object 399 in the visual content 300 is within the content region 311 or the object position is distant from the first content region by less than the distance threshold, the processor 104 may determine that the physical object 399 corresponds to the content region 311. In addition, since the object position of the physical object 399 in the visual content 300 is not within the content regions 312-315 and the object position is not distant from the content regions 312-315 by less than the distance threshold, the processor 104 may determine that the physical object 399 does not correspond to the content regions 311-315, but the disclosure is not limited thereto.

In addition, the processor 104 may further determine whether the first motion state of the physical object 399 indicates that a distance between the physical object 399 and the host 100 is less than a first distance threshold. In various embodiments, the first distance threshold may be about 10 cm, but the disclosure is not limited thereto.

In step S230, in response to determining that the first motion state of the physical object 399 indicates that the distance between the physical object 399 and the host 100 is less than the first distance threshold and the physical object 399 corresponds to the first content region in the visual content 300, the processor 104 performs a first system function corresponding to the first content region.

In the embodiments of the disclosure, the first system function includes at least one of powering off, providing a pass-through view, showing a menu, scrolling the menu, volume adjusting, activating a pass-through view, but the disclosure is not limited thereto.

For example, in response to determining that the distance between the physical object 399 and the host 100 is less than the first distance threshold (e.g., 10 cm) and the object position of the physical object 399 is within the first content region or the object position is distant from the first content region by less than the distance threshold, the processor 104 may perform the first system function corresponding to the first content region.

In the scenario of FIG. 3, since the physical object 399 correspond to the content region 311, the processor 104 may perform the corresponding system function (e.g., powering off the host 100) of the content region 311 if the distance between the physical object 399 and the host 100 is less than the first distance threshold.

In another embodiment, if the physical object 399 is determined to be corresponding to the content region 312, the processor 104 may perform the corresponding system function (e.g., adjusting the volume of the host 100) of the content region 312 if the distance between the physical object 399 and the host 100 is less than the first distance threshold, but the disclosure is not limited thereto.

In another embodiment, in response to determining that the first motion state of the physical object does not indicate that the distance between the physical object 399 and the host 100 is less than the first distance threshold or the physical object 399 does not correspond to the first content region in the visual content 300, the processor 104 may not perform the first system function corresponding to the first content region, but the disclosure is not limited thereto.

Accordingly, when the user intends to activate the first system function, the user does not need to reach/press the corresponding hardware buttons on the body of the host 100. Instead, the user may put, for example, the physical object (e.g., his/her hand) near the host 100 and make the object position of the physical object in the visual content correspond to the first content region for activating the first system function. In this case, the user may activate the desired system function in a more convenient way.

In the embodiments of the disclosure, the first content region corresponds to a first physical region on a body of the host 100. In one embodiment, the first system function corresponding to the first content region may correspond to the system function provided by the first physical region. That is, the when the first physical region is triggered (e.g., pressed/touched), the first system function will be activated as well.

In one embodiment, the first physical region can be disposed with a first physical component for activating the first system function, where the first physical component may be a button, switch, sensor (e.g., a touch sensor, pressure sensor or a proximity sensor), or the like. For example, if the first physical component disposed on the corresponding first physical region is the power button of the host 100, the considered first content region may be the content region 311 in FIG. 3 . . . . For another example, if the first physical component disposed on the corresponding first physical region is the volume button of the host 100, the considered first content region may be the content region 312 in FIG. 3, but the disclosure is not limited thereto.

In one embodiment, no electrical signal would be generated when the first physical component is triggered/pressed. That is, the first physical component is designed with no substantial function, but merely a mechanical element on the body of the host 100. In this case, the user cannot directly activate the first system function via triggering/pressing the first physical component. For example, if the first physical component is the volume button, the user cannot adjust the volume of the host 100 via merely triggering/pressing the first physical component.

In one embodiment, the position of the first physical component can be designed at a particular position where the corresponding object position of the physical object 399 can be determined to be within the first content region or distant from the first content region by less than the distance threshold when the user triggers/presses the first physical component. Therefore, when the user triggers/presses the first physical component, the distance between the physical object 399 and the host 100 can be determined to be less than the first distance threshold and the physical object corresponds to the first content region in the visual content 300.

More specifically, in the embodiment where no electrical signal would be generated when the first physical component is triggered/pressed, the first system function may not be activated when the first physical component is triggered/pressed, but can be activated when the distance between the physical object 399 and the host 100 is determined to be less than the first distance threshold and the physical object corresponds to the first content region in the visual content 300, but the disclosure is not limited thereto.

In one embodiment, the first physical region may be merely a flat region on the body of the host 100 and no electrical signal would be generated when the first physical region is touched/pressed. In this case, the first system function may not be activated when the first physical region is touched/pressed, but can be activated when the distance between the physical object 399 and the host 100 is determined to be less than the first distance threshold and the physical object corresponds to the first content region in the visual content 300, but the disclosure is not limited thereto.

In one embodiment, the visual content 300 includes a reference point P1, and a first relative position between the reference point P1 and the first content region corresponds to a second relative position between a user and the first physical region on the body of the host 100.

In FIG. 3, the reference point P1 may be exemplarily located at the center of the visual content 300. If the considered first content region is the content region 311, the first relative position between the reference point P1 and the content region 311 corresponds to the second relative position between the user and the first physical region on the body of the host 100. That is, in FIG. 3, since the content region 311 is on the upper left of the reference point P1, the first physical region (e.g., the region disposed with the power button) corresponding to the content region 311 is on the upper left of the user as well.

For another example, if the considered first content region is the content region 312, the first relative position between the reference point P1 and the content region 312 corresponds to the second relative position between the user and the first physical region on the body of the host 100. That is, in FIG. 3, since the content region 312 is on the lower left of the reference point P1, the first physical region (e.g., the region disposed with the volume button) corresponding to the content region 312 is on the lower left of the user as well.

In one embodiment, the first content region may be the content region 313. In this case, the corresponding first physical region may include a port connectable with the aforementioned external device. In some embodiments, the port may be currently connecting with the external device or can be used for connecting with the external device, but the disclosure is not limited thereto. Since the content region 313 is on the upper right of the reference point P1, the port is on the upper right of the user as well.

In the embodiments where the icons 311a-315a are invisible by default, the processor 104 may show one or more of the icons 311a-315a in response to determining that the physical object 399 corresponds to one or more of the content regions 311-315.

For example, the processor 104 may show the icon 311a in response to determining that the physical object 399 corresponds to the content region 311. For another example, the processor 104 may show the icon 312a in response to determining that the physical object 399 corresponds to the content region 312.

In one embodiment, in response to determining that the physical object 399 is detected or the physical object 399 corresponds to a specific gesture, the processor 104 may show the corresponding icons 311a-315a of each of the content regions 311-315. In one embodiment, the specific gesture may be, for example, a swiping gesture. That is, when the processor 104 determines that a swiping gesture is detected, the processor 104 may show the icons 311a-315a, but the disclosure is not limited thereto.

In one embodiment, in response to determining that the first motion state of the physical object 399 indicates that the distance between the physical object 399 and the host 100 is not less than the first distance threshold and less than a second distance threshold (e.g., 20 cm) and the physical object 399 corresponds to the first content region in the visual content 300, the processor 104 may perform a second system function corresponding to the first content region, wherein the second distance threshold may be higher than the first distance threshold.

That is, the first content region may be designed with several system functions, and different system function would be activated in response to the detected distance between the physical object 399 and the host 100. If the distance between the physical object 399 and the host 100 is determined to be less than the first distance threshold when the physical object 399 corresponds to the first content region in the visual content 300, the processor 104 may perform the first system function corresponding to the first content region. On the other hand, if the distance between the physical object 399 and the host 100 is determined to be not less than the first distance threshold and less than the second distance threshold when the physical object 399 corresponds to the first content region in the visual content 300, the processor 104 may perform the second system function corresponding to the first content region.

For example, if the considered first content region is the content region 311, the corresponding first system function may be powering off the host 100, and the corresponding second system function may be rebooting the host 100. For another example, if the considered first content region is the content region 312, the corresponding first system function may be turning up the volume of host 100, and the corresponding second system function may be turning down the volume of host 100, but the disclosure is not limited thereto.

In other embodiments, in a case where the first motion state of the physical object 399 indicates that the distance between the physical object 399 and the host 100 is less than the first distance threshold and the physical object 399 corresponds to the first content region in the visual content 300, the processor 104 may perform one or more additional determinations before actually perform the first system function corresponding to the first content region, which would be discussed in the following descriptions.

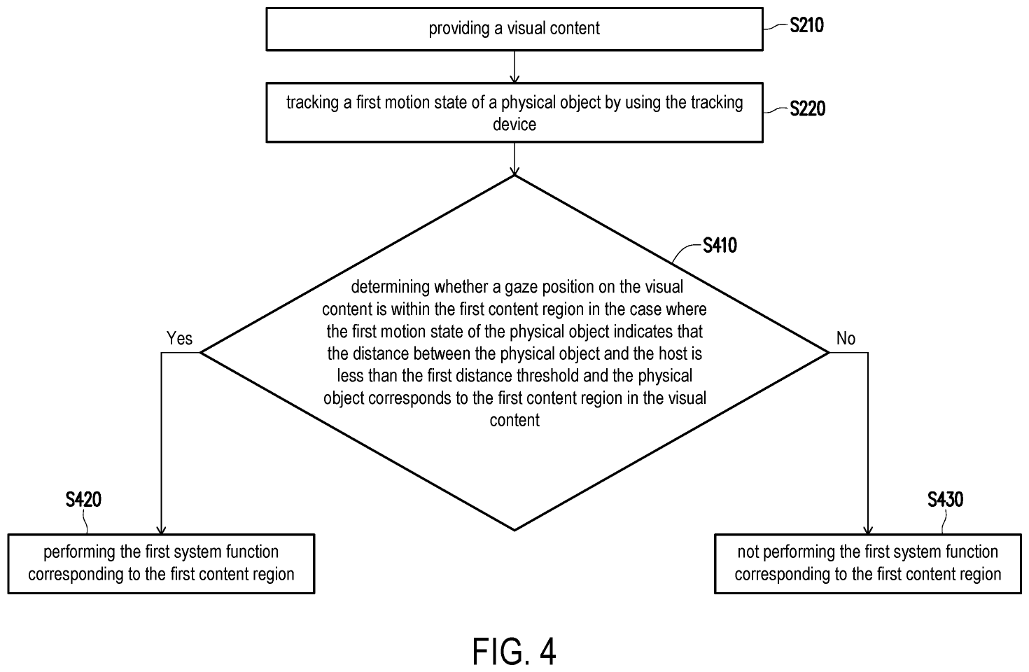

See FIG. 4, which shows a flow chart of the method for activating a system function according to a first embodiment of the disclosure.

In FIG. 4, after performing steps S210 and S220, the processor 104 may further perform step S410 to determine whether an eye gaze position on the visual content 300 is within the first content region in the case where the first motion state of the physical object 399 indicates that the distance between the physical object 399 and the host 100 is less than the first distance threshold and the physical object 399 corresponds to the first content region in the visual content 300.

In one embodiment, the processor 104 may track the eye gaze of the user of the host 100 and accordingly determine the eye gaze position of the user on the visual content 300, but the disclosure is not limited thereto.

In one embodiment, in response to determining that the eye gaze position on the visual content 300 is within the first content region in the case where the first motion state of the physical object 399 indicates that the distance between the physical object 399 and the host 100 is less than the first distance threshold and the physical object 399 corresponds to the first content region in the visual content 300, it represents that the user may intend to activate the first system function corresponding to the first content region. Therefore, the processor 104 may perform step S420 to perform the first system function corresponding to the first content region.

On the other hand, in response to determining that the eye gaze position on the visual content 300 is not within the first content region in the case where the first motion state of the physical object 399 indicates that the distance between the physical object 399 and the host 100 is less than the first distance threshold and the physical object 399 corresponds to the first content region in the visual content 300, it represents that the user may not intend to activate the first system function corresponding to the first content region. Therefore, the processor 104 may perform step S430 to not perform the first system function corresponding to the first content region, but the disclosure is not limited thereto.

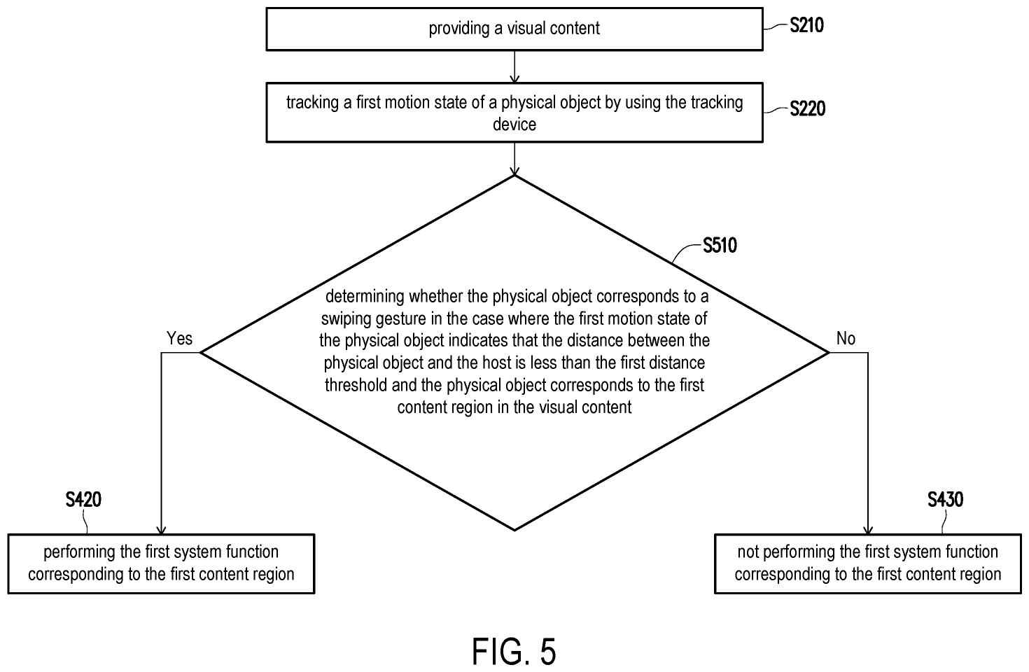

See FIG. 5, which shows a flow chart of the method for activating a system function according to a second embodiment of the disclosure.

In FIG. 5, after performing steps S210 and S220, the processor 104 may further perform step S510 to determine whether the physical object 399 corresponds to a swiping gesture in the case where the first motion state of the physical object 399 indicates that the distance between the physical object 399 and the host 100 is less than the first distance threshold and the physical object 399 corresponds to the first content region in the visual content 300.

In the embodiments where the physical object 399 is the hand of the user, the processor 104 may use the tracking device 106 (e.g., a hand gesture tracking device) to track the hand gesture of the user.

In one embodiment, in response to determining that the physical object 399 corresponds to the swiping gesture in the case where the first motion state of the physical object 399 indicates that the distance between the physical object 399 and the host 100 is less than the first distance threshold and the physical object 399 corresponds to the first content region in the visual content 300, it represents that the user may intend to activate the first system function corresponding to the first content region. Therefore, the processor 104 may perform step S420 to perform the first system function corresponding to the first content region.

On the other hand, in response to determining that the physical object 399 does not correspond to the swiping gesture in the case where the first motion state of the physical object 399 indicates that the distance between the physical object 399 and the host 100 is less than the first distance threshold and the physical object 399 corresponds to the first content region in the visual content 300, it represents that the user may not intend to activate the first system function corresponding to the first content region. Therefore, the processor 104 may perform step S430 to not perform the first system function corresponding to the first content region, but the disclosure is not limited thereto.

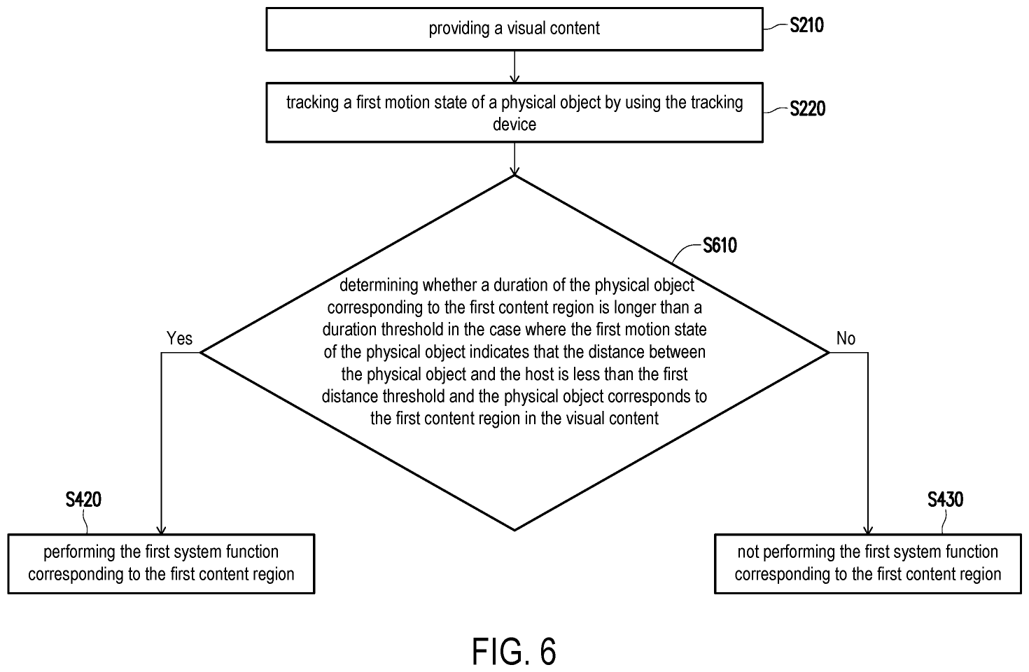

See FIG. 6, which shows a flow chart of the method for activating a system function according to a third embodiment of the disclosure.

In FIG. 6, after performing steps S210 and S220, the processor 104 may further perform step S610 to determine whether a duration of the physical object 399 corresponding to the first content region is longer than a duration threshold in the case where the first motion state of the physical object 399 indicates that the distance between the physical object 399 and the host 100 is less than the first distance threshold and the physical object 399 corresponds to the first content region in the visual content 300.

In one embodiment, the duration of the physical object 399 corresponding to the first content region may be determined as the duration of the object position of the physical object 399 staying in the first content region or distant from the first content region by less than the distance threshold, but the disclosure is not limited thereto.

In one embodiment, in response to determining that the duration of the physical object 399 corresponding to the first content region is longer than the duration threshold in the case where the first motion state of the physical object 399 indicates that the distance between the physical object 399 and the host 100 is less than the first distance threshold and the physical object 399 corresponds to the first content region in the visual content 300, it represents that the user may intend to activate the first system function corresponding to the first content region. Therefore, the processor 104 may perform step S420 to perform the first system function corresponding to the first content region.

On the other hand, in response to determining that the duration of the physical object 399 corresponding to the first content region is not longer than the duration threshold in the case where the first motion state of the physical object 399 indicates that the distance between the physical object 399 and the host 100 is less than the first distance threshold and the physical object 399 corresponds to the first content region in the visual content 300, it represents that the user may not intend to activate the first system function corresponding to the first content region. Therefore, the processor 104 may perform step S430 to not perform the first system function corresponding to the first content region, but the disclosure is not limited thereto.

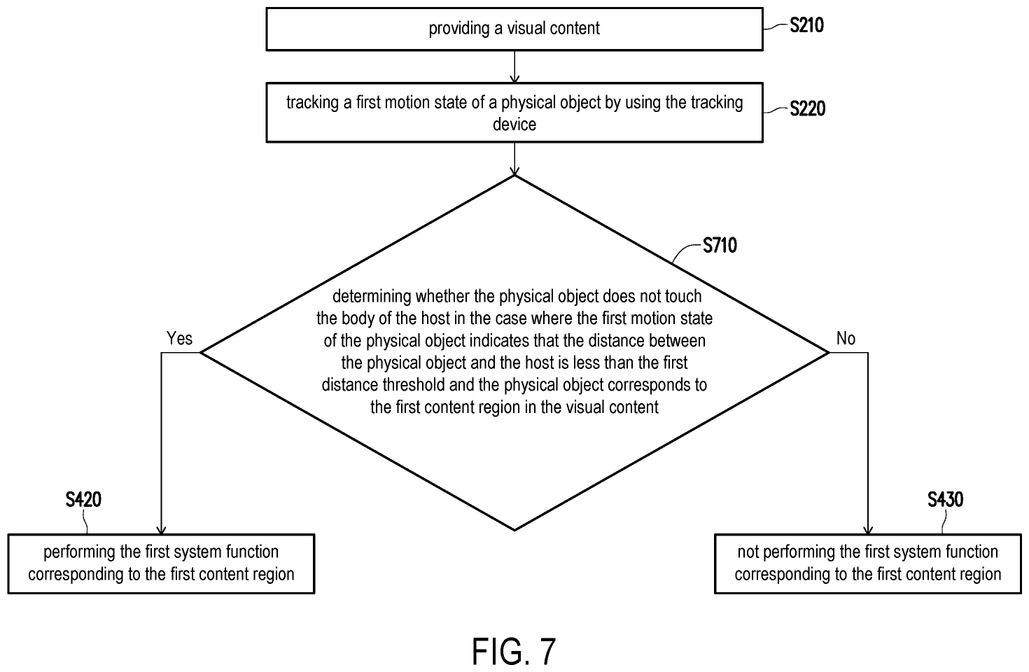

See FIG. 7, which shows a flow chart of the method for activating a system function according to a fourth embodiment of the disclosure.

In FIG. 7, after performing steps S210 and S220, the processor 104 may further perform step S710 to determine whether the physical object 399 does not touch the body of the host 100 in the case where the first motion state of the physical object 399 indicates that the distance between the physical object 399 and the host 100 is less than the first distance threshold and the physical object 399 corresponds to the first content region in the visual content 300.

That is, the processor 104 may determine whether the physical object 399 hovers on the body of the host 100 (e.g., hovers on the first physical region of the host 100) in the case where the first motion state of the physical object 399 indicates that the distance between the physical object 399 and the host 100 is less than the first distance threshold and the physical object 399 corresponds to the first content region in the visual content 300.

In one embodiment, in response to determining that the physical object 399 does not touch the body of the host 100 in the case where the first motion state of the physical object 399 indicates that the distance between the physical object 399 and the host 100 is less than the first distance threshold and the physical object 399 corresponds to the first content region in the visual content 300, it represents that the user may intend to activate the first system function corresponding to the first content region. Therefore, the processor 104 may perform step S420 to perform the first system function corresponding to the first content region.

On the other hand, in response to determining that the physical object 399 touches the body of the host 100 in the case where the first motion state of the physical object 399 indicates that the distance between the physical object 399 and the host 100 is less than the first distance threshold and the physical object 399 corresponds to the first content region in the visual content 300, it represents that the user may not intend to activate the first system function corresponding to the first content region. Therefore, the processor 104 may perform step S430 to not perform the first system function corresponding to the first content region, but the disclosure is not limited thereto.

That is, if the user intends to activate the first system function, the user may hovers the physical object 399 near the first physical region while making the physical object 399 correspond to the first content region, but the disclosure is not limited thereto.

The disclosure further provides a computer readable storage medium for executing the method for activating a system function. The computer readable storage medium is composed of a plurality of program instructions (for example, a setting program instruction and a deployment program instruction) embodied therein. These program instructions can be loaded into the host 100 and executed by the same to execute the method for activating a system function and the functions of the host 100 described above.

In some embodiments, any combinations of steps S410, S510, S610, and S710 may be performed after steps S210 and S220. For example, the processor 104 may determine whether the eye gaze position on the visual content 300 is within the first content region and the physical object 399 corresponds to the swiping gesture in the case where the first motion state of the physical object 399 indicates that the distance between the physical object 399 and the host 100 is less than the first distance threshold and the physical object 399 corresponds to the first content region in the visual content 300.

In one embodiment, in response to determining that the eye gaze position on the visual content 300 is within the first content region and the physical object 399 corresponds to the swiping gesture in the case where the first motion state of the physical object 399 indicates that the distance between the physical object 399 and the host 100 is less than the first distance threshold and the physical object 399 corresponds to the first content region in the visual content 300, the processor 104 may correspondingly perform step S420. Otherwise, the processor 104 may perform step S430. That is, the processor 104 may perform the determination corresponding to the combination of steps S410 and S510 after step S210, and determine to perform steps S420 or S430 accordingly.

For example, the processor 104 may determine whether the eye gaze position on the visual content 300 is within the first content region and the physical object 399 corresponds to the swiping gesture in the case where the first motion state of the physical object 399 indicates that the distance between the physical object 399 and the host 100 is less than the first distance threshold and the physical object 399 corresponds to the first content region in the visual content 300.

In one embodiment, in response to determining that the eye gaze position on the visual content 300 is within the first content region and whether the physical object 399 corresponds to the swiping gesture in the case where the first motion state of the physical object 399 indicates that the distance between the physical object 399 and the host 100 is less than the first distance threshold and the physical object 399 corresponds to the first content region in the visual content 300, the processor 104 may correspondingly perform step S420. Otherwise, the processor 104 may perform step S430. That is, the processor 104 may perform the determination corresponding to the combination of steps S410 and S510 after step S210, and determine to perform steps S420 or S430 accordingly.

For another example, the processor 104 may determine whether the duration of the physical object 399 corresponding to the first content region is longer than the duration threshold and whether the physical object 399 does not touch the body of the host 100 in the case where the first motion state of the physical object 399 indicates that the distance between the physical object 399 and the host 100 is less than the first distance threshold and the physical object 399 corresponds to the first content region in the visual content 300.

In one embodiment, in response to determining that the duration of the physical object 399 corresponding to the first content region is longer than the duration threshold and the physical object 399 does not touch the body of the host 100 in the case where the first motion state of the physical object 399 indicates that the distance between the physical object 399 and the host 100 is less than the first distance threshold and the physical object 399 corresponds to the first content region in the visual content 300, the processor 104 may correspondingly perform step S420. Otherwise, the processor 104 may perform step S430. That is, the processor 104 may perform the determination corresponding to the combination of steps S610 and S710 after step S210, and determine to perform steps S420 or S430 accordingly.

In summary, the embodiments of the disclosure provide a solution for the user to activate the desired system function without reaching/pressing the corresponding hardware buttons on the body of the host. In this case, the user may activate the desired system function in a more convenient way.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for activating a system function, applied to a host, comprising:
providing, by the host, a visual content;
tracking, by the host, a first motion state of a physical object by using a tracking device; and
in response to determining that the first motion state of the physical object indicates that a distance between the physical object and the host is less than a first distance threshold and the physical object corresponds to a first content region in the visual content, performing, by the host, a first system function corresponding to the first content region, wherein the first content region corresponds to a first physical region on a body of the host.

2. The method according to claim 1, wherein the first physical region is disposed with a first physical component.

3. The method according to claim 2, wherein no electrical signal is generated when the first physical component is triggered.

4. The method according to claim 1, wherein the first motion state of the physical object comprises at least one of a moving speed of the physical object, the distance between the physical object and the host, and a duration of the physical object corresponding to the first content region.

5. The method according to claim 1, wherein before performing the first system function corresponding to the first content region, further comprising:
in response to determining that an eye gaze position on the visual content is within the first content region in a case where the first motion state of the physical object indicates that the distance between the physical object and the host is less than the first distance threshold and the physical object corresponds to the first content region in the visual content, performing the first system function corresponding to the first content region; and
in response to determining that the eye gaze position on the visual content is not within the first content region in the case where the first motion state of the physical object indicates that the distance between the physical object and the host is less than the first distance threshold and the physical object corresponds to the first content region in the visual content, not performing the first system function corresponding to the first content region.

6. The method according to claim 1, further comprising:
determining an object position of the physical object in the visual content;
in response to determining that the object position of the physical object is within the first content region or distant from the first content region by less than a distance threshold, determining that the physical object corresponds to the first content region; and
in response to determining that the object position of the physical object is not within the first content region and not distant from the first content region by less than the distance threshold, determining that the physical object does not correspond to the first content region.

7. The method according to claim 1, wherein before performing the first system function corresponding to the first content region, further comprising:
in response to determining that the physical object corresponds to a swiping gesture in a case where the first motion state of the physical object indicates that the distance between the physical object and the host is less than the first distance threshold and the physical object corresponds to the first content region in the visual content, performing the first system function corresponding to the first content region; and
in response to determining that the physical object does not corresponds to the swiping gesture in the case where the first motion state of the physical object indicates that the distance between the physical object and the host is less than the first distance threshold and the physical object corresponds to the first content region in the visual content, not performing the first system function corresponding to the first content region.

8. The method according to claim 1, wherein before performing the first system function corresponding to the first content region, further comprising:
in response to determining that a duration of the physical object corresponding to the first content region is longer than a duration threshold in a case where the first motion state of the physical object indicates that the distance between the physical object and the host is less than the first distance threshold and the physical object corresponds to the first content region in the visual content, performing the first system function corresponding to the first content region; and
in response to determining that a duration of the physical object corresponding to the first content region is not longer than the duration threshold in the case where the first motion state of the physical object indicates that the distance between the physical object and the host is less than the first distance threshold and the physical object corresponds to the first content region in the visual content, not performing the first system function corresponding to the first content region.

9. The method according to claim 1, wherein the first content region comprises a first icon corresponding to the first system function.

10. The method according to claim 9, wherein the first icon is invisible by default, and the method further comprises:
in response to determining that the physical object corresponds to a first content region in the visual content, showing the first icon.

11. The method according to claim 1, wherein the first content region belongs to a plurality of content regions in the visual content, each of the plurality of content regions comprises a corresponding icon, the corresponding icon of each of the plurality of content regions is invisible by default, and the method further comprises:
in response to determining that the physical object is detected or the physical object corresponds to a specific gesture, showing the corresponding icon of each of the plurality of content regions.

12. The method according to claim 1, further comprising:
in response to determining that the first motion state of the physical object indicates that the distance between the physical object and the host is not less than the first distance threshold and less than a second distance threshold and the physical object corresponds to the first content region in the visual content, performing, by the host, a second system function corresponding to the first content region, wherein the second distance threshold is higher than the first distance threshold.

13. The method according to claim 1, wherein before performing the first system function corresponding to the first content region, further comprising:
in response to determining that the physical object does not touch the body of the host in a case where the first motion state of the physical object indicates that the distance between the physical object and the host is less than the first distance threshold and the physical object corresponds to the first content region in the visual content, performing the first system function corresponding to the first content region; and
in response to determining that the physical object touches the body of the host in the case where the first motion state of the physical object indicates that the distance between the physical object and the host is less than the first distance threshold and the physical object corresponds to the first content region in the visual content, not performing the first system function corresponding to the first content region.

14. The method according to claim 1, wherein the visual content comprises a reference point, and a first relative position between the reference point and the first content region corresponds to a second relative position between a user and the first physical region on the body of the host.

15. The method according to claim 1, wherein the first system function comprises at least one of powering off, providing a pass-through view, showing a menu, scrolling the menu, volume adjusting, activating a pass-through view.

16. The method according to claim 1, wherein the first physical region comprises a port connectable with an external device, and the first system function comprises activating a function of the external device.

17. A host, comprising:
a non-transitory storage circuit, storing a program code;
a tracking device; and
a processor, coupled to the non-transitory storage circuit and the tracking device, and accessing the program code to perform:
providing a visual content;
tracking a first motion state of a physical object by using the tracking device; and
in response to determining that the first motion state of the physical object indicates that a distance between the physical object and the host is less than a first distance threshold and the physical object corresponds to a first content region in the visual content, performing a first system function corresponding to the first content region, wherein the first content region corresponds to a first physical region on a body of the host.

18. The host according to claim 17, wherein before performing the first system function corresponding to the first content region, the processor further performs:
in response to determining that an eye gaze position on the visual content is within the first content region in a case where the first motion state of the physical object indicates that the distance between the physical object and the host is less than the first distance threshold and the physical object corresponds to the first content region in the visual content, performing the first system function corresponding to the first content region;
in response to determining that the eye gaze position on the visual content is not within the first content region in the case where the first motion state of the physical object indicates that the distance between the physical object and the host is less than the first distance threshold and the physical object corresponds to the first content region in the visual content, not performing the first system function corresponding to the first content region.

19. The host according to claim 17, wherein the processor further performs:
in response to determining that the first motion state of the physical object indicates that the distance between the physical object and the host is not less than the first distance threshold and the physical object corresponds to the first content region in the visual content, performing, by the host, a second system function corresponding to the first content region.

20. A non-transitory computer readable storage medium, the computer readable storage medium recording an executable computer program, the executable computer program being loaded by a host to perform steps of:
providing a visual content;
tracking a first motion state of a physical object by using a tracking device; and
in response to determining that the first motion state of the physical object indicates that a distance between the physical object and the host is less than a first distance threshold and the physical object corresponds to a first content region in the visual content, performing a first system function corresponding to the first content region, wherein the first content region corresponds to a first physical region on a body of the host.
